(19) United States
(12) Patent Application Publication
(10) Pub. No.: US 2017/0097310 A1
(43) Pub. Date: Apr. 6, 2017

(54) METHOD AND DEVICE FOR DETERMINING STRUCTURE OF MULTI-ELEMENT CRYSTAL

(71) Applicant: SAMSUNG ELECTRONICS CO., LTD., Suwon-si (KR)

(72) Inventors: You Young SONG, Yongin-si (KR); Kyoung Min MIN, Seoul (KR); Seung-Woo SEO, Suwon-si (KR); Eun Seog CHO, Yongin-si (KR); Jin Seok HONG, Seoul (KR)

(21) Appl. No.: 15/281,648

(22) Filed: Sep. 30, 2016

(30) Foreign Application Priority Data
Oct. 2, 2015 (KR) 10-2015-0139352

(51) Int. Cl. G01N 23/22

(52) U.S. Cl. CPC G01N 23/22; G01N 2223/603

(57) ABSTRACT

A method for determining a stable structure of a multi-element crystal, the method including: determining a multi-layered matrix of the multi-element crystal based on a layer of the multi-element crystal and a composition ratio of transition metals included in the multi-element crystal; grouping candidate structures of the multi-element crystal into a plurality of candidate structure groups based on a trace of the multi-layered matrix; and determining at least one stable structure group including the stable structure from among the plurality of candidate structure groups to determine the stable structure.

### CROSS-REFERENCE TO RELATED APPLICATION

This application claims priority to and the benefit of Korean Patent Application No. 10-2015-0139352, filed in the Korean Intellectual Property Office on Oct. 2, 2015, and all the benefits accruing therefrom under 35 U.S.C. §119, the entire content of which is incorporated herein by reference.

### BACKGROUND

(a) Field

A method and a device for determining a stable structure of multi-element crystal are disclosed.

(b) Description of the Related Art

One method for finding a stable structure of a crystal system is to use the density functional theory (DFT) (also known as a first-principles calculation). The density functional theory is a theory used for calculating forms and energy of electrons or molecules positioned in a material, and is based on quantum mechanics. However, the DFT takes a long time to calculate a structure so its use may be limited in a case where several candidate structures are to be evaluated. For example, multi-element cathode materials such as a lithium nickel cobalt manganese oxide (LiNiₓCo_{y}Mn_{1-x-y}O₂, “NCM”) or a lithium nickel cobalt aluminum oxide (LiNiₓCo_{y}Al_{1-x-y}O₂, “NCA”) may have several thousands to several tens of thousands of candidate structures, depending on the exact structure or composition of the material, so it is difficult to apply the DFT.

As a result, there is a need for an improved method of determining a crystal structure of multi-element crystal.

### SUMMARY

Studies to develop a new method for predicting the structure of a multi-element crystal using an algorithm have progressed. One example is a method for measuring the structure of the crystal system using both a local order matrix and the DFT. This method uses structural information of a small unit cell acquired through calculation of the DFT as a single unit cell, and combining the information from the unit cells to form a structure of a material to be predicted. The local order matrix may be used to express an arrangement of atoms included in the structure.

A method and device for efficiently and quickly determining a stable structure of multi-element crystal are provided herein.

An exemplary embodiment provides a method for determining a stable structure of a multi-element crystal, the method including: determining a multi-layered matrix of the multi-element crystal based on a layer of the multi-element crystal and a composition ratio of transition metals included in the multi-element crystal; grouping candidate structures of the multi-element crystal into a plurality of candidate structure groups based on a trace of the multi-layered matrix; and determining at least one stable structure group including the stable structure from among the plurality of candidate structure groups to determine the stable structure.

The determining of a multi-layered matrix may include determining a structure matrix from a plurality of structure matrices to be the multi-layered matrix, wherein a composition ratio of the transition metals is identical for each structure matrix in the plurality of structure matrices.

The determining of the structure matrix from the plurality of structure matrices to be the multi-layered matrix may include determining a structure matrix having the greatest trace from among the plurality of structure matrices to be the multi-layered matrix.

Among diagonal entries of the multi-layered matrix, an entry a₁₁ may be the greatest value of all entries in the multi-layered matrix.

Among diagonal entries of the multi-layered matrix, an entry aₜₜ may be a value that is equal to or greater than an entry a_{t+1 t+1}.

The determining of the at least one stable structure group may include: randomly selecting at least one representative candidate structure from each candidate structure group of the plurality of structure groups; calculating a mean energy of the at least one representative candidate structure; and determining the candidate structure group having a least mean energy to be the stable structure group.

The calculating may include: calculating a mean energy of the at least one representative candidate structure using density functional theory (DFT).

The method may further include: calculating a mean energy of a plurality of candidate structures in the stable structure group; and determining the candidate structure having the least energy to be the most stable structure.

The method may further include acquiring a structural characteristic of the at least one stable structure group.

Another embodiment provides a device for determining a stable structure of multi-element crystal, the device including: a multi-layered matrix determiner configured to determine a multi-layered matrix of the multi-element crystal based on a layer of the multi-element crystal and a composition ratio of transition metals included in the multi-element crystal; a grouper configured to group candidate structures of the multi-element crystal into a plurality of candidate structure groups based on a trace of the multi-layered matrix; and a group determiner configured to determine at least one stable structure group including the stable structure from among the plurality of candidate structure groups.

The multi-layered matrix determiner may be configured to determine a structure matrix from a plurality of structure matrices to be the multi-layered matrix, wherein a composition ratio of the transition metals is identical for each structure matrix in the plurality of structure matrices.

The multi-layered matrix determiner may be configured to determine the structure matrix having the greatest trace from among the plurality of structure matrices to be the multi-layered matrix.

An entry a₁₁ from among diagonal entries of the multi-layered matrix may have the greatest value from among all entries of the multi-layered matrix.

Among diagonal entries of the multi-layered matrix entry aₜₜ may be equal to or greater than an entry a_{t+1 t+1}.

The group determiner may be configured to randomly select at least one representative candidate structure from among each candidate group of the plurality of candidate structure groups, calculate mean energy of the at least one representative candidate structure, and determine the candidate structure group having a least mean energy to be the stable structure group.

The group determiner may be configured to calculate mean energy of the at least one representative candidate structure using density functional theory (DFT).

The device may further include a stable structure determiner configured to calculate energy of a plurality of candidate structures included in the stable structure group and to determine the candidate structure having a least energy to be the most stable structure.

The device may further include a structure analyzer configured to acquire a structural characteristic of the stable structure group.

Yet another embodiment provides a device for determining a stable structure of a multi-element crystal, the device including: at least one processor; and a memory, wherein the at least one processor executes at least one program stored in the memory and is configured to: determine a structure matrix for the multi-element crystal based on a layer of the multi-element crystal and a composition ratio of transition metals included in the multi-element crystal, group candidate structures of the multi-element crystal into a plurality of candidate structure groups based on the determined structure matrix, and determine at least one stable structure group including the stable structure from among the plurality of candidate structure groups.

According to the embodiments, the candidate structures may be quickly grouped to reveal structural similarities between a large number of possible structures that randomly exist, and the stable structure of the multi-element crystal may be efficiently searched for and identified by comparing the energy of respective groups.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 shows a flowchart of a method for determining a stable structure of multi-element crystal according to an exemplary embodiment;

FIG. 2A shows a structure of multi-element crystal and FIG. 2B shows a structure matrix of the of multi-element crystal, according to an exemplary embodiment;

FIG. 3 shows a schematic view of a method for determining a multi-layered matrix from a structure matrix, according to an exemplary embodiment;

FIG. 4 shows a plurality of multi-layered matrices, according to an exemplary embodiment;

FIG. 5A is a graph of energy (electron volts per atom, eV/atom) versus NCM111 candidate structure number and FIG. 5B is a graph of energy (eV/atom) versus the trace value, which show an energy distribution graph of a multi-element crystal, according to an exemplary embodiment;

FIG. 6A shows a structure of multi-element crystal, FIG. 6B is a graph of energy (eV/atom) versus NCM111 candidate structure number, and FIG. 6C is a graph of energy (eV/atom) versus the trace value of a multi-element crystal, according to another exemplary embodiment;

FIG. 7A shows a structure of multi-element crystal, FIG. 7B is a graph of energy (eV/atom) versus NCM111 candidate structure number, and FIG. 7C is a graph of energy (eV/atom) versus the trace value of a multi-element crystal, according to another exemplary embodiment;

FIG. 8 shows a device for determining a stable structure of multi-element crystal according to an exemplary embodiment; and

FIG. 9 shows a device for determining a stable structure of multi-element crystal according to an exemplary embodiment.

### DETAILED DESCRIPTION

In the following detailed description, only certain exemplary embodiments have been shown and described, simply by way of illustration. As those skilled in the art would realize, the described embodiments may be modified in various different ways, all without departing from the spirit or scope of invention. Accordingly, the drawings and description are to be regarded as illustrative in nature and not restrictive. Like reference numerals designate like elements throughout the specification.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

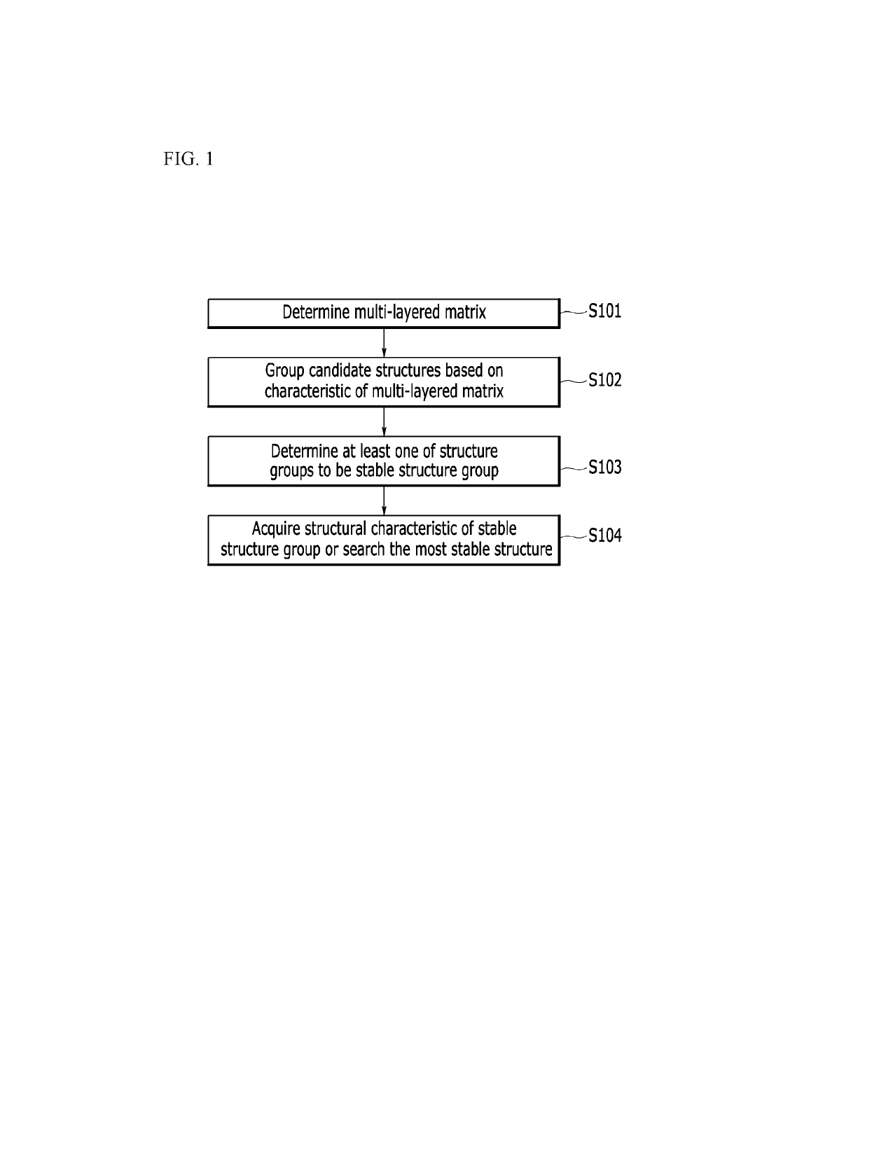

FIG. 1 shows a flowchart of a method for determining a stable structure of multi-element crystal according to an exemplary embodiment.

Referring to FIG. 1, a multi-layered matrix on multi-element crystal is determined based on a structure of multi-element crystal for finding a stable structure (S101). The structure of the multi-element crystal may be expressed as an image or text by a program executed by a processor.

In an exemplary embodiment, the multi-layered matrix may express an arrangement state of elements included in the multi-element crystal, and may be determined from among a plurality of structure matrices. The element of multi-element crystal is provided on a layer of the multi-element crystal structure, and the layer includes a site on which the element of multi-element crystal may be provided. That is, an element of the multi-element crystal may be provided on the site included in the layer of the multi-element crystal structure, so that a relationship between the structure of the multi-element crystal and the element may be expressed by the structure matrix and the multi-layered matrix, in an exemplary embodiment.

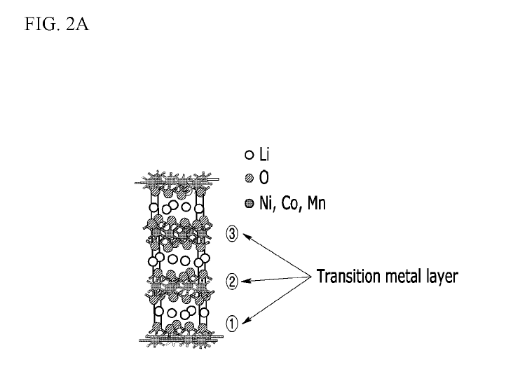

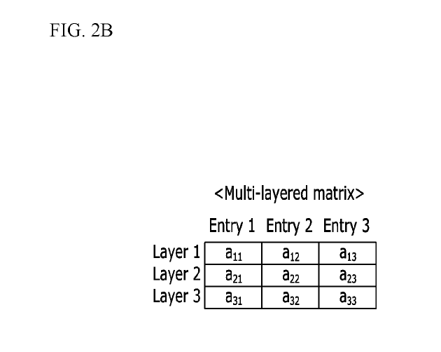

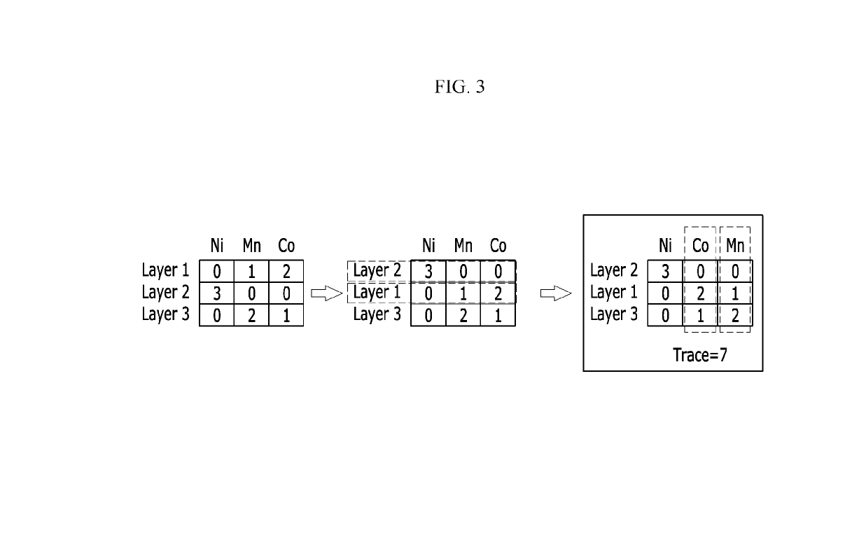

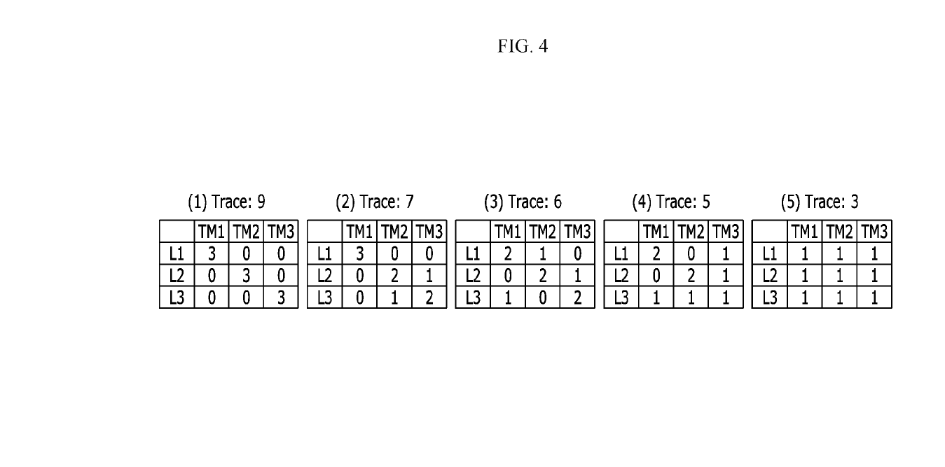

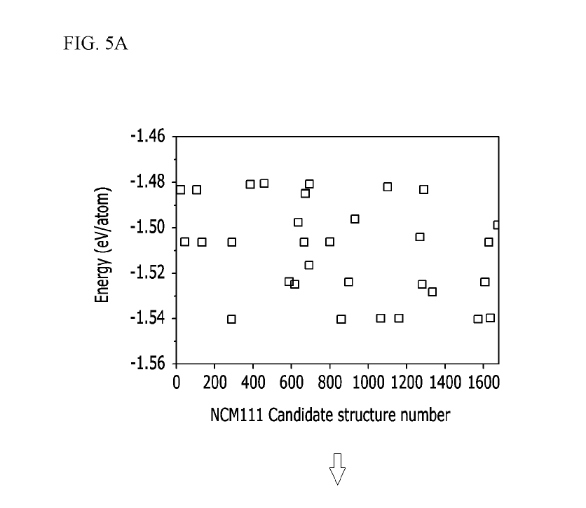

FIG. 2 shows a structure of multi-element crystal and a structure matrix according to an exemplary embodiment, FIG. 3 shows a schematic view of a method for determining a multi-layered matrix from a structure matrix according to an exemplary embodiment, and FIG. 4 shows a multi-layered matrix according to an exemplary embodiment.

Referring to FIGS. 2A and 2B, a structure of a nickel, cobalt, manganese (NCM) multi-element crystal NCM111 and a structure matrix of the multi-element crystal NCM111 are shown. The structure of the multi-element crystal NCM111 includes an R30 space group including three transition metal layers. The structure matrix may be determined based on a composition ratio of transition metals included in multi-element crystal.

For example, the NCM111 may be the multi-element crystal LiNi_{1/3}Co_{1/3}Mn_{1/3}O₂, in which nickel, manganese, and cobalt are provided on the respective layers (e.g. transition metal layers) of NCM111, and are included in a unit cell at a same ratio (e.g., 1:1:1). In the case of the NCM111 shown in FIGS. 2A and 2B (e.g. LiNi_{1/3}Co_{1/3}Mn_{1/3}O₂), one unit cell includes nine transition metals, three different sites where the transition metal is provided on the respective layers, and the composition ratio of the transition metals is 1:1:1. In FIG. 2B, each row of the structure matrix corresponds to a layer of the multi-element crystal, and each column corresponds to a specific type of transition metal included in the multi-element crystal. In another way, the respective rows of the structure matrix may correspond to the type of transition metal included in the multi-element crystal and the respective columns may correspond to the layer of the multi-element crystal. That is, the layers of the multi-element crystal and the type of transition metals included in the multi-element crystal may correspond to the rows or the columns of the structure matrix.

Hence, an entry aᵢⱼ of the structure matrix may be represented transition metal j included in the multi-element crystal and the layer i on which the transition metal is provided. When i is equal to j, respective layers include N sites, and j transition metals are arranged to the maximum on the respective layers, the entry aᵢⱼ included in the layer i may follow the rule of Equation 1.

(1) aᵢⱼ and N are natural numbers

(2) aᵢ₁+aᵢ₂+ . . . +aᵢⱼ=N

(3) 0≦aᵢⱼ≦N

(4) j={1,2, . . . ,MAX(i)=MAX(j)} Equation 1

When j is greater than i, i transition metals are selected in order of the largest composition ratio, and when i is greater than j, the entries of the columns that are greater than a (j+1)th order are set to 0 (e.g., aᵢⱼ=0 where i>j) to configure the structure matrix.

Referring to FIG. 3, a method for determining a multi-layered matrix from a structure matrix is shown. The matrix shown on the left of FIG. 3 is a structure matrix indicating the structure of the multi-element crystal NCM111 including one manganese and two cobalt on the first layer, three nickel on the second layer, and two manganese and one cobalt on the third layer. That is, the row of the structure matrix may be determined according to the composition ratio of the transition metals in a single layer. The multi-element crystal includes a plurality of layers so one structure matrix may correspond to a plurality of composition ratios of the transition metals. The structure matrix shown in FIG. 3 includes one row with the composition ratio of transition metals as 3:0:0 (e.g. 3 parts of a first metal and 0 parts of the other second and third metals) and two rows with the composition ratio as 2:1:0 (e.g. 2 parts of a first metal, 1 part of a second metal, and 0 part of the third metal) so the structure matrices shown in FIG. 3 correspond to the composition ratios of transition metals as 3:0:0 and 2:1:0. That is, the composition ratios of transition metals of 3:0:0 and 2:1:0 identically corresponds to the respective structure matrices shown in FIG. 3. A plurality of structure matrices in which the composition ratio of transition metals is identical may become same multi-layered matrices. This is because the multi-layered matrix of the multi-element crystal according to an exemplary embodiment, may be determined by controlling the order of rows and columns of the structure matrix so that a trace of the structure matrix may be maximized. That is, the structure matrix with the greatest trace from among a plurality of structure matrices in which the composition ratio of transition metals is identical for each structure matrix in the plurality of structure matrices, may be determined to be the multi-layered matrix.

For example, the structure matrix shown in the middle of FIG. 3, is formed by changing a position of the row so that the row including the most of one transition metal may be provided on a first place relative to the rows in the structure matrix shown on the left side of FIG. 3. The structure matrix shown on the right side of FIG. 3 is formed by changing the position of the column so that the trace of the matrix may be at a maximum. That is, the structure matrix is a multi-layered matrix. That is, FIG. 3 shows a method for finding or generating a structure matrix having the greatest trace from among a plurality of structure matrices in which the composition ratio of transition metals is identical for each structure matrix in the plurality of structure matrices. The trace of the structure matrix in the multi-element crystal is provided when the sum of the diagonal entries of the structure matrix is at the maximum, which occurs when the entry with the greatest size in each of the respective rows is positioned as part of the diagonal entry of the structure matrix that is a multi-layered matrix. The diagonal entry included in the multi-layered matrix may follow Equation 2. Equation 2 expresses the rule of the diagonal entry when multi-element crystal includes m layers.

(1) a₁₁≧a₂₂≧ . . . ≧aₘₙ,∴aₜₜ≧a_{t+1 t+1}

(2) aₜₜ=MAX(aᵢⱼ),i,jε{t,t+1, . . . ,m},1≦t≦m Equation 2

The trace of a multi-layered matrix according to an exemplary embodiment is a value for indicating clustering information of an element included in the multi-element crystal. That is, the trace of the multi-layered matrix may be determined by the sum of the diagonal entries in the multi-layered matrix, and the fact that the size of the diagonal entry is large signifies that a large number of specific elements are provided on the respective layers of the multi-element crystal. For example, when the composition ratio of manganese:cobalt:nickel provided in a specific layer is 3:0:0, three manganese are present and no cobalt and no nickel are present, which may be considered to be highly clustered. Alternatively, when the composition ratio of manganese:cobalt:nickel provided in a different layer is 1:1:1, it means that one manganese, one cobalt, and one nickel are present, which may be determined to be less clustered. Therefore, when the respective elements are clustered to the maximum on all layers, the trace of the multi-layered matrix becomes a maximum, and the clustered degree of the element included in the multi-element crystal may be expressed by the trace of the multi-layered matrix and may be used as a factor for determining a stable structure group.

FIG. 4 shows all possible multi-layered matrices for the multi-element crystal NCM111. TM1, TM2, and TM3 are transition metals and are one of nickel, cobalt, and manganese, and the order of the three elements may be changed when the structure matrix is transformed into the multi-layered matrix. The structure matrix of NCM111 may exist when the traces are 3, 5, 6, 7, and 9. That is, the structure matrix with the trace of 4 or 8 may not be established. The composition ratio of the transition metals of the multi-element crystal NCM111 is 1:1:1 and the respective layers have three transition metal sites, so the composition ratio of transition metals provided on the respective layers is one of 3:0:0, 2:1:0, or 1:1:1, and the respective rows of the structure matrix of NCM111 may become [3, 0, 0], [2, 1, 0], or [1, 1, 1]. When the multi-layered matrix of NCM111 includes the row of [3, 0, 0], the first row of the multi-layered matrix is designated as [3, 0, 0]. Further, when the multi-layered matrix of NCM111 includes a row of [1, 1, 1], the last row of the multi-layered matrix is designated as [1, 1, 1].

Referring to FIG. 4, the trace of the first multi-layered matrix in which all layers (e.g., three layers) of the multi-element crystal structure have the composition ratio of transition metals of 3:0:0 is 9 (trace=3+3+3). The trace of the second multi-layered matrix in which the first layer of the multi-element crystal structure has the composition ratio of transition metals as 3:0:0, and the second layer and the third layer have the same composition ratio of 2:1:0, is 7 (trace=3+2+2). The trace of the third multi-layered matrix in which the composition ratio of transition metals in all layers is 2:1:0, is 6 (trace=2+2+2). The trace of the fourth multi-layered matrix in which the first layer and the second layer of the multi-element crystal structure has the composition ratio of transition metals of 2:1:0, and the third layer has the composition ratio of 1:1:1, is 5 (trace=2+2+1). The trace of the fifth multi-layered matrix in which the composition ratio of transition metals in all layers is 1:1:1, is 3 (trace=1+1+1).

As described above, three layers of the multi-element crystal structure and three elements included in the multi-element crystal are provided (e.g., the structure matrix is a square matrix). According to another exemplary embodiment, the multi-layered matrix may also be determined from the structure matrix when the number of layers is different from the number of elements. That is, when the number of rows and columns of the structure matrix are different from each other (e.g., when the structure matrix is not a square matrix), the largest entry of each row is arranged in a downward direction of the diagonal, which begins at the entry a₁₁ of the structure matrix, and 0 is inserted into the last row or column. Thus, the trace may be accordingly calculated.

With reference to FIG. 1, candidate structures are grouped based on a characteristic of the multi-layered matrix (S102). The characteristic of the multi-layered matrix may be the trace of the multi-layered matrix. That is, regarding the method for determining a stable structure of multi-element crystal according to an exemplary embodiment, the candidate structures may be grouped by the respective traces of the multi-layered matrix. For example, the nine transition metals included in the multi-element crystal NCM111, may be nickel, cobalt, and manganese at a same composition ratio so the number of candidate structures of the multi-element crystal NCM111 is 1680 (=₉C₃×₆C₃×₃C₃). The trace of the multi-layered matrix of NCM111 is one of 3, 5, 6, 7, and 9, so the 1680 candidate structures of the multi-element crystal may be grouped into five candidate structure groups according to the total number (five) of traces.

According to another exemplary embodiment, the candidate structures may be grouped according to a determinant of the structure matrix. For example, in the case of the second multi-layered matrix (trace: 7) from among the multi-layered matrices shown in FIG. 4, the order of the respective rows may be determined from six other structure matrices, and in detail, the candidate structures may be grouped based on the determinants of the six structure matrices. For example, one of the structure matrices corresponding to the second multi-layered matrix, and one of the structure matrices corresponding to the third multi-layered matrix may have a same determinant as shown in Equation 3 so the two structure matrices may be grouped into the same group.

$$det \vert \begin{matrix}0 & 1 & 2 \\ 0 & 2 & 1 \\ 3 & 0 & 0\end{matrix} \vert = det \vert \begin{matrix}0 & 1 & 2 \\ 1 & 2 & 0 \\ 2 & 0 & 1\end{matrix} \vert = - 9 \qquad Equation 3$$

When the group for the candidate structures of multi-element crystal is grouped based on the determinant, the degree to which the elements are clustered may be determined based on the determinant. To maximize the determinant of the structure matrix, all the elements of the multi-element crystal are each provided on a different layer as much as possible, so the clustered degree is determined to be large when the determinant of the structure matrix is small, and the clustered degree is determined to be small when the determinant of the structure matrix is large.

Further, the structure of multi-element crystal may be grouped based on the characteristic, such as the trace of the multi-layered matrix or the structure matrix, or alternatively, the determinant according to the structural characteristic of the multi-element crystal may be searched.

When the candidate structures of the multi-element crystal are grouped into a plurality of candidate structural groups, a stable structure group including the most stable structure may be determined from among a plurality of candidate structure groups (S103). At least one stable structure group may be determined.

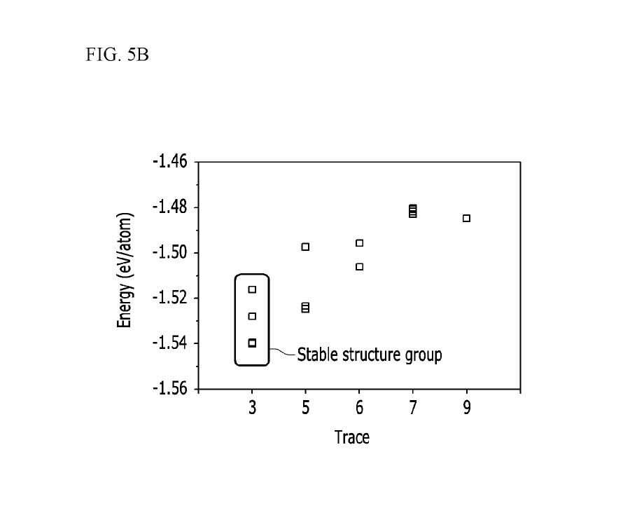

FIG. 5 shows an energy distribution graph of multi-element crystal according to an exemplary embodiment.

According to an exemplary embodiment, the stable structure group may be determined by calculating energy of a selected representative structure when a predetermined number of representative structures are selected from among candidate structures in the candidate structure groups. That is, the mean energy of the representative structures may be calculated and the group having the lowest mean energy may be determined to be the stable structure group. The energy of the representative structure may be calculated through a quantum simulation (QS) using the DFT. At least one stable structure group may be selected, according to an exemplary embodiment.

Referring to FIG. 5A, a horizontal axis (x-axis) indicates the number (1-1680) of the candidate structure of the NCM111 multi-element crystal including nine transition metals, and a vertical axis (y-axis) shows the energy of the candidate structure. Referring to FIG. 5B, the horizontal axis represents the trace (or a group number) of the candidate structure group of the NCM111 multi-element crystal including nine transition metals, and a vertical axis indicates the energy of the representative structure of the candidate structure group. That is, the upper graph indicates an energy distribution for respective candidate structures of the NCM111 crystal, and the lower graph shows an energy distribution for the respective candidate structure groups of the NCM111 crystal.

Regarding FIG. 5A, the energy distribution for the candidate structures of the NCM111 crystal does not display any particular pattern, but regarding FIG. 5B, the energy of the representative structures of the candidate structure groups has a tendency to increase as the trace increases. Therefore, according to the graph of FIG. 5B, the mean energy of the group where the trace is 3, is lower than the mean energy of any of the other groups, and thus the group with the trace of 3 may be determined to be the stable structure group. It may be also found that the groups with similar clustered degrees have similar structural stabilities.

Table 1 shows multi-layered matrices of the structure groups, traces, and candidate structures of the graph of FIG. 5B.

TABLE 1

| Groups | Group 1 | Group 2 | Group 3 | | Group 4 | Group 5 |
|---|---|---|---|---|---|---|
| Multi-layered | 1 1 1 | 2 0 1 | 2 1 0 | 2 0 1 | 3 0 0 | 3 0 0 |
| matrices | 1 1 1 | 0 2 1 | 0 2 1 | 1 2 0 | 0 2 1 | 0 3 0 |
| | 1 1 1 | 1 1 1 | 1 0 2 | 0 1 2 | 0 1 2 | 0 0 3 |

| | | | | | |
|---|---|---|---|---|---|
| Traces | 3 | 5 | 6 | 7 | 9 |
| 1680 | 216 | 972 | 324 | 162 | 6 |
| candidate | | | | | |
| structures | | | | | |

According to an exemplary embodiment, the stabilities of energy levels of the candidate structures included in the respective groups are similar for the respective candidate structures, so when a predetermined number of representative structures are randomly selected from among the candidate structures included in the candidate structure group and the mean energy of the representative structures is calculated, the stable structure group that is estimated to include the most stable structure may be determined.

A structural characteristic of the stable structure group is acquired or the most stable structure may be searched from the stable structure group if needed (S104). The structural characteristic of the stable structure group relates to a method in which respective elements included in multi-element crystal are provided on the respective layers. Regarding searching for the most stable structure, the candidate structure with the lowest energy may be calculated using DFT on the candidate structures included in the stable structure group.

Referring to FIGS. 5A and 5B and Table 1, since group 1 is determined to be a stable structure group, the most stable NCM111 structure has the structural characteristic in which three transition metals (nickel, cobalt, and manganese) are disposed on each of the respective layers. Further, the DFT is calculated for the 216 candidate structures included in group 1 so the candidate structure with the least energy size may be determined.

Therefore, according to the method for determining a stable structure of multi-element crystal according to an exemplary embodiment, the most stable structure of multi-element crystal may be efficiently determined. For example, assuming that it takes about ten hours to apply the DFT and calculate energy of one candidate structure, it will take about two years to calculate the energy of the 1680 candidate structures of the NCM111. However, according to the method for determining a stable structure of multi-element crystal according to an exemplary embodiment, when the energy for five representative structures is calculated in five groups, the stable structure group may be determined within about ten days, and when the DFT is calculated for all candidate structures included in the stable structure group, the most stable structure may be determined within 100 days.

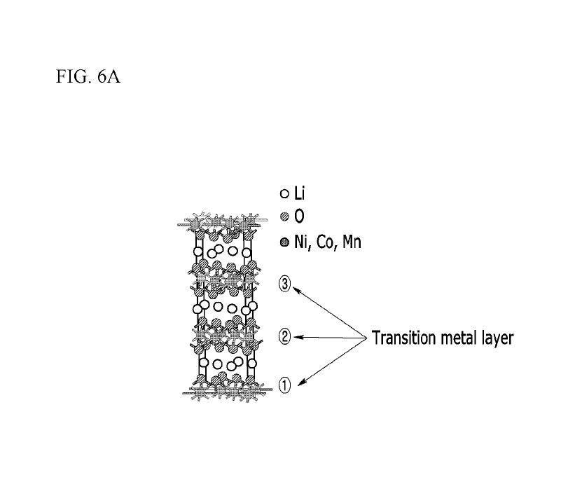

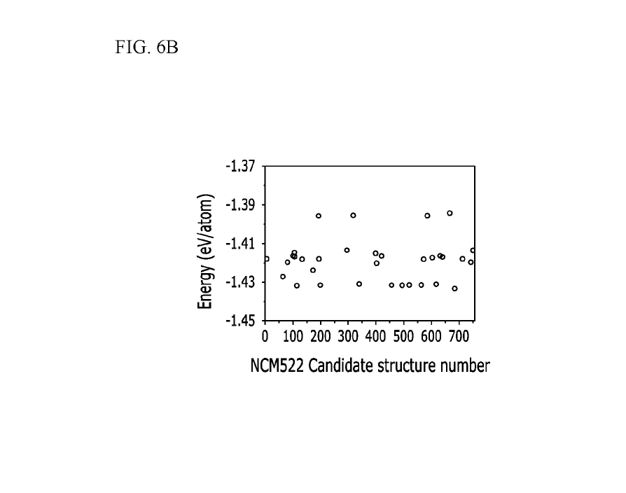

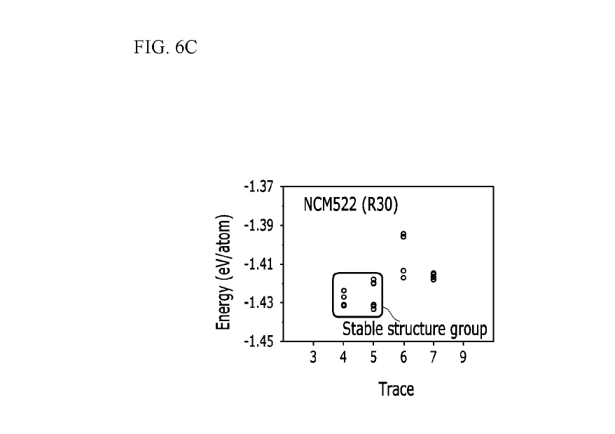

FIG. 6A shows a structure of multi-element crystal, and FIGS. 6B and 6C show energy distribution graphs of a multi-element crystal, according to another exemplary embodiment.

In FIG. 6A, a structure of the multi-element crystal NCM522 (LiNi_{5/9}CO_{2/9}Mn_{2/9}O₂), an energy distribution graph (FIG. 6B) for respective candidate structures of NCM522, and an energy distribution graph (FIG. 6C) of respective candidate structure groups determined through the calculation of the trace for the multi-layered matrix of the NCM522, are shown.

Regarding the structure of the NCM522 crystal, where the space group is R30, the composition ratio of nickel:cobalt:manganese is 5:2:2, there are three transition metal layers, and nine transition metals in a single unit cell. The trace of the multi-layered matrix for the multi-element crystal NCM522 with space group R30 may be 4, 5, 6, and 7. Therefore, the candidate structure of the NCM522 crystal may be grouped into four groups based on the four traces.

A horizontal axis of the graph in FIG. 6B indicates the number (1-756, 756=₉C₅×₄C₂×₂C₂) of the candidate structures of the NCM522 crystal, and a vertical axis represents the energy of the candidate structures. A horizontal axis of the graph in FIG. 6C represents the trace (or a group number) of the group of the NCM522 crystal, and a vertical axis indicates energy of the representative structures of the candidate structure groups. That is, FIG. 6B shows the energy distribution for the respective candidate structures of the NCM522 crystal and FIG. 6C represents the energy distribution for the respective groups of the NCM522 crystal.

Regarding FIG. 6B, the energy distribution for the candidate structures of the NCM522 crystal does not display any particular pattern, but regarding FIG. 6C, the energy of the representative structures of the groups show a tendency to increase as the trace increases. Table 2 shows multi-layered matrices, traces, and candidate structures of the groups shown in FIG. 6A.

TABLE 2

| Groups | Group 1 | Group 2 | | Group 3 | Group 4 |
|---|---|---|---|---|---|
| Multi-layered | 2 0 1 | 2 0 1 | 3 0 0 | 3 0 0 | 3 0 0 |
| matrices | 2 1 0 | 1 2 0 | 1 1 1 | 0 2 1 | 1 2 0 |
| | 1 1 1 | 2 0 1 | 1 1 1 | 2 0 1 | 1 0 2 |

| | | | | |
|---|---|---|---|---|
| Traces | 4 | 5 | 6 | 7 |
| 756 | 324 | 270 | 108 | 54 |
| candidate | | | | |
| structures | | | | |

According to FIG. 6B and Table 2, the mean energy of the groups have a trace of 4 or 5 is less than the mean energy of other groups, so the group 1 and the group 2 may be determined to be the stable structure groups. When the structural characteristic of the candidate structures included in the group 1 and the group 2 are acquired, or if needed, the DFT on all candidate structures included in the group 1 and the group 2 is calculated, the most stable structure may be determined.

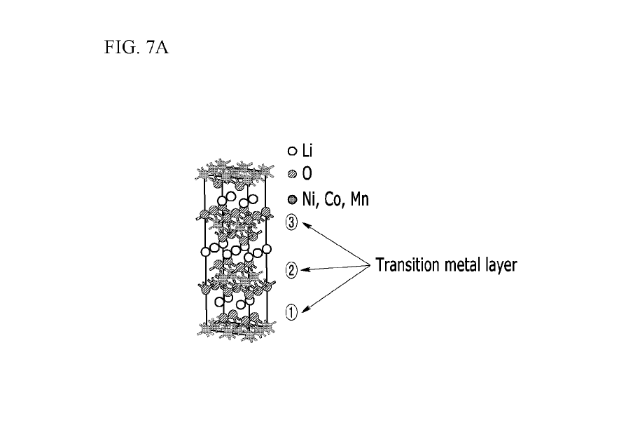

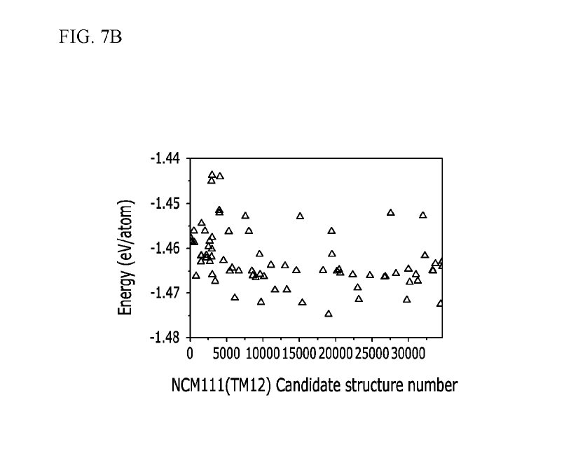

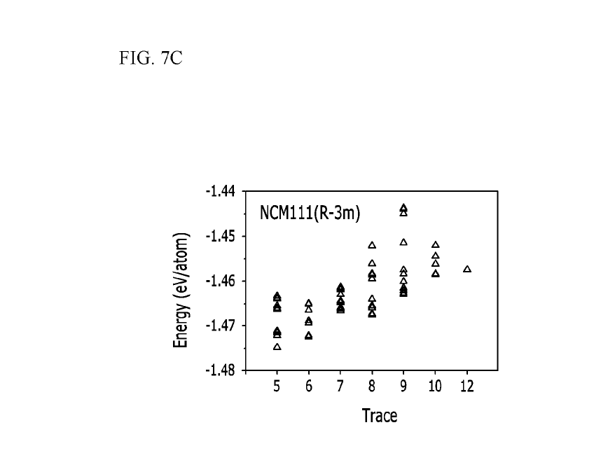

FIG. 7 shows a structure of multi-element crystal and an energy distribution graph of multi-element crystal according to another exemplary embodiment.

In FIGS. 7A to 7C, a structure of NCM111-TM12 including twelve transition metals having an R-3m space group (FIG. 7A), an energy distribution graph (FIG. 7B) for respective candidate structures of the NCM111-TM12, and an energy distribution graph (FIG. 7C) of the respective groups determined by calculating the trace of the multi-layered matrix of the NCM111-TM12, are shown.

A structure of a lithium nickel cobalt manganese oxide (LiNiₓCo_{y}Mn_{1-x-y}O₂, NCM) is not clear, but is known through experiments to have the space group of R-3m. Regarding the NCM111-TM12 structure, twelve transition metals are provided on three layers by four respectively so the number of the candidate structures of NCM111-TM12 is 34,560 (=₁₂C₄×₈C₄×₄C₄). Therefore, when only the DFT is calculated for all candidate structures of NCM111-TM12, it will take about forty years to calculate the energy so it is difficult to search for the stable structure through the calculation of the DFT alone. The NCM111-TM12 with the composition ratio of nickel:cobalt:manganese as 1:1:1 has a structure having three layers for each unit cell and four transition metals for each layer, and the trace of the multi-layered matrix may be 5, 6, 7, 8, 9, 10, and 12. Therefore, the candidate structures of the NCM111-TM12 may be grouped into seven groups.

A horizontal axis of FIG. 7B shows numbers (1-34,560) of the candidate structure of NCM111-TM12 crystal, and a vertical axis is the energy of the corresponding candidate structure. A horizontal axis of the graph in FIG. 7C indicates a trace (or a group number) of the group of the NCM111-TM12 crystal, and a vertical axis indicates energy of the representative structures of the respective candidate structure groups. That is, FIG. 7B represents the energy distribution for respective candidate structures of the NCM111-TM12 crystal, and FIG. 7C indicates the energy distribution for respective groups of the NCM111-TM12 crystal.

Regarding FIG. 7B, the energy distribution for the candidate structures of the NCM111-TM12 crystal does not show a particular pattern, but regarding FIG. 7C, the energies of the representative structures of the groups have a tendency to increase as the trace increases. Table 3 shows multi-layered matrices and traces of respective groups shown in FIG. 7C.

TABLE 3

| Groups | Group 1 | Group 2 | | Group 3 | Group 4 | | Group 5 | Group 6 | Group 7 |
|---|---|---|---|---|---|---|---|---|---|
| Multi-layered | 2 0 2 | 2 1 1 | 2 2 0 | 3 1 0 | 3 0 1 | 4 0 0 | 3 1 0 | 4 0 0 | 4 0 0 |
| matrices | 1 2 1 | 1 2 1 | 0 2 2 | 0 2 2 | 0 3 1 | 0 2 2 | 0 3 1 | 0 3 1 | 0 4 0 |
| | 1 2 1 | 1 1 2 | 2 0 2 | 1 1 2 | 1 1 2 | 0 2 2 | 1 0 3 | 0 1 3 | 0 0 4 |

| | | | | | | | |
|---|---|---|---|---|---|---|---|
| Traces | 5 | 6 | 7 | 8 | 9 | 10 | 12 |

According to FIG. 7C and Table 3, ten representative structures are selected from each group, the mean representative structure of the representative structures is calculated, and the group 1 may be determined as the stable structure group. When the structural characteristics of the candidate structures included in group 1 are acquired, or if needed, the DFT on all candidate structures included in the group 1 is calculated, the most stable structure may be determined. In this case, ten representative structures are selected for seven groups, and the DFT is operated for seventy representative structures, so it would take about thirty days to select the stable structure group. That is, a time saving effect of more than 99% is generated compared to the case in which the DFT is operated for all candidate structures.

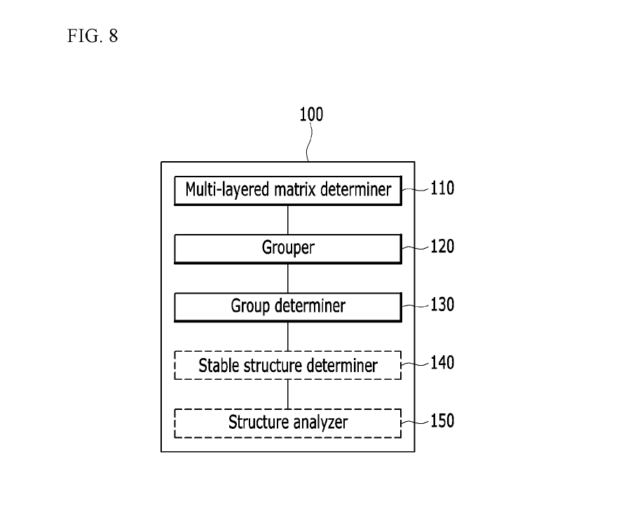

FIG. 8 shows a device for determining a stable structure of multi-element crystal according to an exemplary embodiment.

Referring to FIG. 8, a device 100 for determining a stable structure of multi-element crystal according to an exemplary embodiment includes a multi-layered matrix determiner 110, a grouper 120, and a group determiner 130.

The multi-layered matrix determiner 110 is configured to determine the multi-layered matrix of the multi-element crystal based on the layer of multi-element crystal and the composition ratio of the transition metals included in the multi-element crystal. The multi-layered matrix determiner 110 may generate a structure matrix of the multi-element crystal and may determine the multi-layered matrix based on the structure matrix. That is, when a plurality of structure matrices in which the composition ratio of transition metals is identical for each structure matrix in the plurality of structure matrices, the multi-layered matrix determiner 110 may determine one of a plurality of structure matrices to be the multi-layered matrix. Here, the multi-layered matrix may be determined to be the structure matrix having the greatest trace from among the plurality of structure matrices with identical composition ratios of transition metals.

The grouper 120 is configured to group the candidate structures of multi-element crystal into a plurality of candidate structure groups based on the trace of the multi-layered matrix. The trace of the multi-layered matrix may be determined to be plural, and the candidate structures with the same trace may be grouped in a same group. Alternatively, the grouper 120 according to another exemplary embodiment may group the candidate structures with the same determinant of the structure matrix as the same group.

The group determiner 130 is configured to determine the stable structure group including a stable structure from among a plurality of candidate structure groups. The stable structure group may be determined based on the energy size of the representative structures selected from the respective candidate structure groups. For example, when a plurality of representative structures are selected from the respective candidate structure groups, the group determiner 130 may calculate the mean energy of a plurality of representative structures and may determine the candidate structure group with the least mean energy to be the stable structure group. The group determiner 130 may calculate the energy of the representative structure by applying the DFT calculation to the representative structure.

Further, the device 100 for determining a stable structure according to an exemplary embodiment may also include a stable structure determiner 140 and a structure analyzer 150.

The stable structure determiner 140 may be configured to calculate the energy of all candidate structures included in the stable structure group, and may determine the candidate structure with the least energy to be the most stable structure.

The structure analyzer 150 may be configured to acquire the structural characteristic of the stable structure group.

As described above, according to the exemplary embodiments, the candidate structures may be quickly grouped so that structural similarities of a large number of structures randomly exist, and the stable structure of multi-element crystal may be searched with efficiency by comparing energy for respective groups.

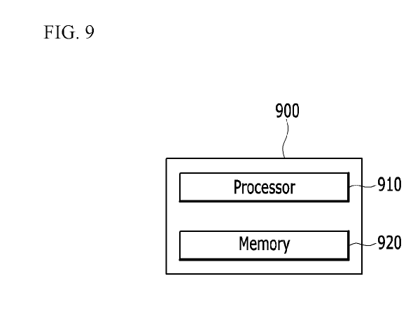

FIG. 9 shows a device for determining a stable structure of the multi-element crystal according to an exemplary embodiment.

The device 900 for determining a stable structure of multi-element crystal according to an exemplary embodiment may include a processor 910 and a memory 920. The memory 920 may be connected to the processor 910, and may store various types of information for driving the processor 910 or at least one program performed by the processor 910. The processor 910 may realize a function, a process, or a method proposed in an exemplary embodiment. An operation of the device 900 for determining a structure of multi-element crystal according to an exemplary embodiment may be realized by the processor 910.

In an exemplary embodiment, the memory 920 may be provided inside or outside of the processor 910, and may be connected to the processor 910 through various means known to a person skilled in the art. The memory 920 represents a volatile or non-volatile storage medium in various forms, and for example, the memory 920 may include a read-only memory (ROM) and a random access memory (RAM).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for determining a stable structure of a multi-element crystal, the method comprising:
determining a multi-layered matrix of the multi-element crystal based on a layer of the multi-element crystal and a composition ratio of transition metals comprised in the multi-element crystal;
grouping candidate structures of the multi-element crystal into a plurality of candidate structure groups based on a trace of the multi-layered matrix; and
determining at least one stable structure group comprising the stable structure from among the plurality of candidate structure groups to determine the stable structure.

2. The method of claim 1, wherein
the determining of a multi-layered matrix includes
determining a structure matrix from a plurality of structure matrices to be the multi-layered matrix, wherein a composition ratio of the transition metals is identical for each structure matrix in the plurality of structure matrices.

3. The method of claim 2, wherein
the determining of the structure matrix from the plurality of structure matrices to be the multi-layered matrix comprises
determining a structure matrix having the greatest trace from among the plurality of structure matrices to be the multi-layered matrix.

4. The method of claim 1, wherein
among diagonal entries of the multi-layered matrix an entry a₁₁ is the greatest value of all entries in the multi-layered matrix.

5. The method of claim 1, wherein
among diagonal entries of the multi-layered matrix, an entry aₜₜ is equal to or greater than an entry a_{t+1 t+1}.

6. The method of claim 1, wherein
the determining of the at least one stable structure group comprises:
randomly selecting at least one representative candidate structure from each candidate structure group of the plurality of candidate structure groups;
calculating mean energy of the at least one representative candidate structure; and
determining the candidate structure group having a least mean energy to be the stable structure group.

7. The method of claim 6, wherein
the calculating includes:
calculating a mean energy of the at least one representative candidate structure using density functional theory.

8. The method of claim 1, further comprising:
calculating a mean energy of a plurality of candidate structures in the stable structure group; and
determining the candidate structure having the least energy to be the most stable structure.

9. The method of claim 1, further comprising:
acquiring a structural characteristic of the at least one stable structure group.

10. A device for determining a stable structure of multi-element crystal, the device comprising:
a multi-layered matrix determiner configured to determine a multi-layered matrix of the multi-element crystal based on a layer of the multi-element crystal and a composition ratio of transition metals comprised in the multi-element crystal;
a grouper configured to group candidate structures of the multi-element crystal into a plurality of candidate structure groups based on a trace of the multi-layered matrix; and
a group determiner configured to determine at least one stable structure group comprising the stable structure from among the plurality of candidate structure groups.

11. The device of claim 10, wherein
the multi-layered matrix determiner is configured to determine a structure matrix from a plurality of structure matrices to be the multi-layered matrix, wherein a composition ratio of the transition metals is identical for each structure matrix in the plurality of structure matrices.

12. The device of claim 11, wherein
the multi-layered matrix determiner is configured to determine the structure matrix having the greatest trace from among the plurality of structure matrices to be the multi-layered matrix.

13. The device of claim 10, wherein
among diagonal entries of the multi-layered matrix an entry a₁₁ is the greatest value of all entries in the multi-layered matrix.

14. The device of claim 10, wherein
among diagonal entries of the multi-layered matrix an entry aₜₜ is equal to or greater than an entry a_{t+1 t+1}.

15. The device of claim 10, wherein
the group determiner is configured to randomly select at least one representative candidate structure from each candidate structure group of the plurality of candidate structure groups, calculate mean energy of the at least one representative candidate structure, and determine the candidate structure group having a least mean energy to be the stable structure group.

16. The device of claim 15, wherein
the group determiner is configured to calculate mean energy of the at least one representative candidate structure using density functional theory.

17. The device of claim 10, further comprising
a stable structure determiner configured to calculate energy of a plurality of candidate structures comprised in the stable structure group and to determine the candidate structure having a least energy to be the most stable structure.

18. The device of claim 10, further comprising
a structure analyzer configured to acquire a structural characteristic of the stable structure group.

19. A device for determining a stable structure of a multi-element crystal, the device comprising:
at least one processor; and
a memory,
wherein the at least one processor executes at least one program stored in the memory and the program is configured to:
determine a structure matrix for the multi-element crystal based on a layer of the multi-element crystal and a composition ratio of transition metals comprised in the multi-element crystal,
group candidate structures of the multi-element crystal into a plurality of candidate structure groups based on a determinant of the structure matrix, and
determine at least one stable structure group comprising the stable structure from among the plurality of candidate structure groups.
